(19) United States
(12) Patent Application Publication
(10) Pub. No.: US 2026/0025630 A1
(43) Pub. Date: Jan. 22, 2026

(54) METHODS, DEVICES, AND SYSTEMS FOR REPRODUCING SPATIAL AUDIO USING BINAURAL EXTERNALIZATION PROCESSING EXTENSIONS

(71) Applicant: Virtuel Works LLC, Aptos, CA (US)

(72) Inventor: Jean-Marc Jot, Aptos, CA (US)

(21) Appl. No.: 19/339,341

(22) Filed: Sep. 25, 2025

Related U.S. Application Data
(63) Continuation of application No. PCT/US24/21627, filed on Mar. 27, 2024.
(60) Provisional application No. 63/454,915, filed on Mar. 27, 2023.

(51) Int. Cl. H04S 7/00

(52) U.S. Cl. CPC H04S 7/303; H04S 2420/11

(57) ABSTRACT

Disclosed herein are methods, systems, and devices for reproducing spatial audio using binaural externalization processing extensions. In one embodiment, a method includes receiving an audio source signal and generating a directional signal by applying directional processing to the audio source signal. The method further includes generating a tail output signal by applying diffuse tail processing to the audio source signal. The tail output signal is representative of the directional signal. Additionally, the tail output signal is configured for conveying diffuse localization. The method further includes generating an externalized signal by combining the directional signal and tail output signal. Additionally, the externalized signal is configured for conveying directional localization.

### PRIORITY CLAIM

This patent application is a continuation of PCT Patent Application No. PCT/US2024/021627, titled “METHODS, DEVICES, AND SYSTEMS FOR REPRODUCING SPATIAL AUDIO USING BINAURAL EXTERNALIZATION PROCESSING EXTENSIONS,” filed on Mar. 27, 2024, which claims the benefit of priority to U.S. Provisional Patent Application No. 63/454,915, titled “BINAURAL EXTERNALIZATION PROCESSING EXTENSIONS,” filed Mar. 27, 2023, which are all incorporated by reference herein in their entireties.

### TECHNICAL FIELD

The present invention relates generally to the field of binaural reproduction. Additionally, the present invention relates generally to the field of virtual reality (VR) and augmented reality. More particularly, methods, devices, and systems are disclosed for reproducing spatial audio using binaural externalization processing extensions.

### BACKGROUND

Spatial audio reproduction allows playback of sound at the ears of a listener in such a way that recreates a real-world experience. In both entertainment and professional applications, conventionally produced stereo or multi-channel audio content is frequently delivered over headphones or earbuds. A head-mounted wearable display device such as a Virtual Reality (VR) headset and/or an Augmented Reality (AR) headset also operates as a binaural reproduction device if it incorporates a pair of loudspeakers (left and right), each transmitting its input signal to a respective ear of the listener wearing the device. Virtual reality (VR) provides users an immersion into an artificial environment created within one or more computing systems. Augmented reality (AR) provides users overlays of virtual reality (and/or virtual objects) onto their real world environment. Basically, the user's real world is enhanced with virtual reality. Mixed reality provides more than just the overlays, but also anchors virtual reality to the users' real world. Users are allowed to interact simultaneously with both the real world and the virtual world. Applying spatial audio of VR and AR applications greatly enhances the user experience.

Accordingly, there remains a need for improved methods, devices, and systems for reproducing spatial audio.

### SUMMARY

Disclosed herein are methods, systems, and devices for reproducing spatial audio using binaural externalization processing extensions. In one embodiment, a method includes receiving an audio source signal and generating a directional signal by applying directional processing to the audio source signal. The method further includes generating a tail output signal by applying diffuse tail processing to the audio source signal. The tail output signal is representative of the directional signal. Additionally, the tail output signal is configured for conveying diffuse localization. The method further includes generating an externalized signal by combining the directional signal and tail output signal. Additionally, the externalized signal is configured for conveying directional localization.

In some embodiments, the method may further include storing the externalized signal in a memory.

In some embodiments, the method may further include applying downmixing to the audio source signal prior to applying the diffuse tail processing.

In further embodiments, the normalization processing may be configured for ensuring that the tail output signal is representative of the directional signal.

In some embodiments, applying the downmixing to the audio source signal may include preservation of per-source interaural time differences (ITD).

In some embodiments, applying the downmixing to the audio source signal may include normalization processing.

In some embodiments, the method may further include applying gain correction to the directional signal prior to combining the directional signal and the tail output signal.

In some embodiments, applying diffuse tail processing may include applying a delay network.

In some embodiments, the delay network may include at least one feedback delay network (FDN).

In some embodiments, applying diffuse tail processing may include applying a frequency-dependent rotation matrix.

In some embodiments, the frequency-dependent rotation matrix may include a first shelving filter and a second shelving filter. In further embodiments, the first shelving filter may have a first power frequency response over a frequency range targeted for a user; and the second shelving filter may have a second power frequency response over the frequency range targeted for the user. In further embodiments, the first power frequency response may be complementary to the second power frequency response. In still further embodiments, the first shelving filter may include a high-pass equalizer and the second shelving filter may include a low-pass equalizer.

In some embodiments, applying diffuse tail processing may further include applying at least one feedback delay network (FDN) in cascade with the frequency-dependent rotation matrix.

In some embodiments, the method may further include applying reflections and/or reverb to the audio source signal to generate a reverb output signal.

In some embodiments, the method may further include applying a diffuse-field head-related transfer function (HRTF) filter to the reverb output signal and combining an output of the diffuse-field HTRF filter with the externalized signal.

In some embodiments, applying directional processing may include applying interaural time difference.

In some embodiments, externalized signal may be representative of the audio source signal.

In some embodiments, the audio source signal may be a multi-channel audio source signal, a binaural source signal, and an Ambisonic audio source signal having a W component channel, or the like.

In some embodiments, the audio source signal may be an Ambisonic audio source signal and the diffuse tail processing may be applied to the W component channel of the audio source signal.

In some embodiments, at least a portion of the method may be implemented by one or more processors.

In some embodiments, at least a portion of the method may be implemented by one or more application specific integrated circuits (ASICs).

In some embodiments, at least a portion of the method may be implemented by one or more digital signal processors (DSPs).

In some embodiments, at least a portion of the method is implemented by one or more field programmable gate arrays (FPGAs).

In some embodiments, the method may further include transmitting the externalized signal over a communication interface.

In some embodiments, the communication interface may be a wired interface, a radio frequency (RF) interface, an optical fiber interface, a free space optical interface, or the like.

In some embodiments, the communication interface may be a personal area network (PAN) interface. In further embodiments, the PAN interface may be compliant to at least one version of a Bluetooth® standard.

In other embodiments, the communication interface may be a local area network (LAN) interface. In further embodiments, the LAN interface may be compliant to at least one version of an Ethernet standard. In other embodiments, the LAN interface may be compliant to at least one version of a Wi-Fi standard.

In still other embodiments, the communication interface may be a wide area network (LAN) interface. In further embodiments, the WAN interface may be compliant to at least one version of a cellular standard.

In some embodiments, the method may further include providing the externalized signal to playback circuitry. The playback circuitry may include at least two loudspeakers.

In certain embodiments, the playback circuitry may be implemented in a virtual reality (VR) headset, an augmented reality (AR) headset, and/or the like. In further embodiments, the VR headset may be an Oculus Quest@ VR headset, an Oculus Quest 2 VR headset, an Oculus Go headset, a Pico Neo® 1 VR headset, a Pico Neo 2 VR headset, a Pico Neo 3 VR headset, a Pico Goblin® 1 VR headset, a Pico Goblin 2 VR headset, an HTC VIVE Focus@ VR headset, HTC VIVE Focus Plus VR headset, an HTC VIVE Focus 3 VR headset, or the like. In still further embodiments, the AR headset may be a Hololens® 1 AR headset, a Hololens 2 AR headset, and a Magic Leap® 1 AR headset, or the like.

In other embodiments, the playback circuitry may be implemented in a smartphone, a smart tablet, a laptop, a personal computer, a workstation, a soundbar, or the like.

In some embodiments, at least a portion of the method may be implemented by a set of headphones, a set of earbuds, a set of hearing aids, or the like.

In another embodiment, a computing device including at least one processor and a memory is disclosed. The computing device is configured for receiving an audio source signal and generating a directional signal by applying directional processing to the audio source signal. The computing device is further configured for generating a tail output signal by applying diffuse tail processing to the audio source signal. The tail output signal is representative of the directional signal. Additionally, the tail output signal is configured for conveying diffuse localization. The computing device is further configured for generating an externalized signal by combining the directional signal and tail output signal. Additionally, the externalized signal is configured for conveying directional localization.

In another embodiment, an application specific integrated circuit (ASIC) including at least one processor and a memory is disclosed. The ASIC is configured for receiving an audio source signal and generating a directional signal by applying directional processing to the audio source signal. The ASIC is further configured for generating a tail output signal by applying diffuse tail processing to the audio source signal. The tail output signal is representative of the directional signal. Additionally, the tail output signal is configured for conveying diffuse localization. The ASIC is further configured for generating an externalized signal by combining the directional signal and tail output signal. Additionally, the externalized signal is configured for conveying directional localization.

In another embodiment, a non-transitory computer-readable storage medium is disclosed. The non-transitory computer-readable storage medium stores instructions to be implemented on at least one computing device including at least one processor. The instructions when executed by the at least one processor cause the at least one computing device to perform a method. The method includes receiving an audio source signal and generating a directional signal by applying directional processing to the audio source signal. The method further includes generating a tail output signal by applying diffuse tail processing to the audio source signal. The tail output signal is representative of the directional signal. Additionally, the tail output signal is configured for conveying diffuse localization. The method further includes generating an externalized signal by combining the directional signal and tail output signal. Additionally, the externalized signal is configured for conveying directional localization.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

FIG. 1 depicts a block diagram illustrating binaural reproduction and the loudspeaker reproduction of various types of audio source signals in accordance with embodiments of the present disclosure.

FIG. 2 depicts a diagram illustrating a commonly reported listening experience during the binaural reproduction of a circular motion of an audio object in the horizontal plane, recorded with a dummy head microphone in accordance with embodiments of the present disclosure.

FIG. 3A depicts a diagram illustrating a listener with a left loudspeaker and a right loudspeaker in accordance with embodiments of the present disclosure.

FIG. 3B depicts a diagram illustrating a commonly perceived in-head localization in the binaural audio playback of two-channel stereo audio signals in accordance with embodiments of the present disclosure.

FIG. 4 depicts a diagram illustrating, in a top-down view, the intended localization to be perceived by a listener in the binaural reproduction of a two-channel stereo audio source signal in accordance with embodiments of the present disclosure.

FIG. 5 depicts a functional diagram illustrating directional processing of a five-channel audio source signal designed for playback in the standard surround-sound loudspeaker configuration shown in FIG. 1 in accordance with embodiments of the present disclosure.

FIG. 6 depicts a functional diagram illustrating a signal flow diagram illustrating the binaural externalization processing of an audio source signal in accordance with embodiments of the present disclosure.

FIG. 7 depicts a flowchart illustrating a method for illustrating a method for reproducing spatial audio using binaural externalization processing extensions in accordance with embodiments of the present disclosure.

FIG. 8 depicts a graph illustrating a simplified plot of interchannel coherence of a two-channel signal conveying diffuse localization in binaural reproduction in accordance with embodiments of the present disclosure.

FIG. 9A depicts a functional diagram illustrating a signal flow diagram illustrating the binaural externalization processing of a multi-channel audio source signal composed of a set of elementary single-channel audio source signals feeding a shared diffuse tail processing block, in accordance with embodiments of the present disclosure.

FIG. 9B depicts a graph illustrating two plots from a pair of filters in accordance with embodiments of the present disclosure.

FIG. 10 depicts a block diagram illustrating a system including a virtual reality/augmented reality (VR/AR) device for providing binaural externalization processing extensions for reproducing spatial audio in accordance with embodiments of the present disclosure.

FIG. 11 depicts a block diagram illustrating the VR/AR device of FIG. 10 in accordance with embodiments of the present disclosure.

FIG. 12 depicts a block diagram illustrating a server in accordance with embodiments of the present disclosure.

FIG. 13 depicts a block diagram illustrating a mobile device for providing spatial audio in accordance with embodiments of the present disclosure.

FIG. 14 depicts a functional diagram illustrating binaural externalization processing of an audio source signal in accordance with embodiments of the present disclosure.

FIG. 15 depicts a functional diagram illustrating binaural externalization processing of a multi-channel source signal in accordance with embodiments of the present disclosure.

FIG. 16 depicts a functional diagram illustrating directional processing of a multi-channel source signal in accordance with embodiments of the present disclosure.

FIG. 17 depicts a functional diagram illustrating externalization processing of a multi-channel source signal accordance with embodiments of the present disclosure.

FIG. 18 depicts a functional diagram illustrating externalization processing of an Ambisonic source signal in accordance with embodiments of the present disclosure.

FIG. 19 depicts a functional diagram illustrating externalization processing of a binaural source signal in accordance with embodiments of the present disclosure.

FIG. 20 depicts a functional diagram illustrating externalization processing of a binaural source signal in accordance with embodiments of the present disclosure.

FIG. 21 depicts a functional diagram illustrating externalization processing of a binaural source signal in accordance with embodiments of the present disclosure.

FIG. 22 depicts a functional diagram illustrating externalization processing of a multi-channel source signal in accordance with embodiments of the present disclosure.

FIG. 23 depicts a functional diagram illustrating externalization processing of a multi-channel source signal in accordance with embodiments of the present disclosure.

FIG. 24 depicts a functional diagram illustrating externalization processing of a multi-channel source signal in accordance with embodiments of the present disclosure.

FIG. 25 depicts a functional diagram illustrating a diffuse tail processing block in accordance with embodiments of the present disclosure.

FIG. 26 depicts a functional diagram illustrating a diffuse tail processing block in accordance with embodiments of the present disclosure.

FIG. 27 depicts a functional diagram illustrating a diffuse tail processing block in accordance with embodiments of the present disclosure.

FIG. 28 depicts a functional diagram illustrating a diffuse tail processing block in accordance with embodiments of the present disclosure.

FIG. 29A depicts a functional diagram illustrating a realization of a frequency-dependent rotation matrix in accordance with embodiments of the present disclosure.

FIG. 29B depicts a graph illustrating an example of the power frequency responses of shelving filters in accordance with embodiments of the present disclosure.

FIG. 29C depicts a functional diagram illustrating a realization of power-complementary shelving filters in accordance with embodiments of the present disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Disclosed herein are methods, systems, and devices for reproducing spatial audio using binaural externalization processing extensions.

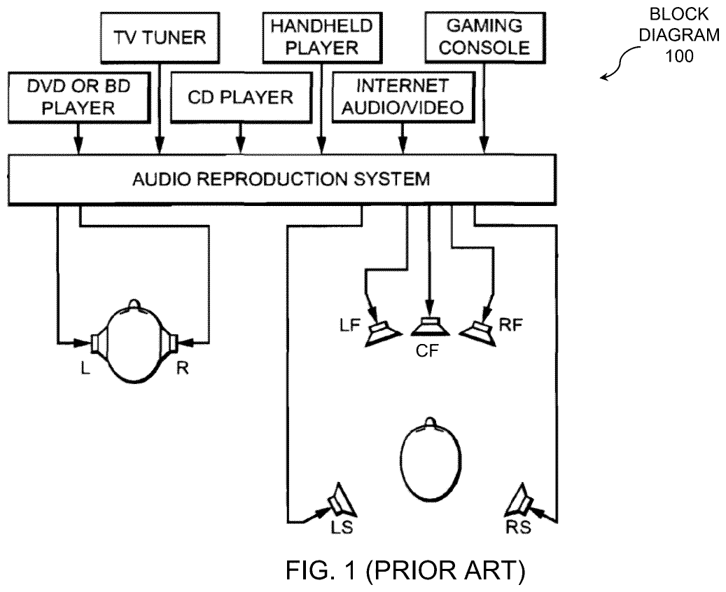

FIG. 1 depicts a block diagram 100 illustrating binaural reproduction and the loudspeaker reproduction of various types of audio source signals in accordance with embodiments of the present disclosure. The types of audio content consumed via binaural reproduction devices include music, movies, podcasts, games, VR and audio conference or communication applications. In many use cases, the audio content is transmitted or delivered in the form of a single-channel (a.k.a. mono) audio source signal suitable for playback over a single loudspeaker (for instance a front-center loudspeaker, CF) or a two-channel stereo audio source signal suitable for playback over a pair of loudspeakers in conventional stereo arrangement (LF, RF). In some use cases, the audio source signal is delivered in an surround or immersive multi-channel or object-based audio distribution format such as Dolby Atmos, DTS-X or MPEG-H. A two-channel, multi-channel or object-based audio source signal is composed of or perceived as one or several single-channel audio source signals, each assigned an intended localization in auditory space relative to the listener's head position and orientation. The combination of an audio source signal and its intended localization data is referred to as an audio object. An audio object may represent a music instrument, a group of instruments, a voice of a human talker, and/or the like.

The appreciation of binaural reproduction experiences by listeners is typically compromised by the unintended or unnatural perception of the localization of audio objects, wherein an audio object's localization as perceived by the listener does not match its intended localization. Audio objects are often heard near or inside the listener's head even when their intended localization is distant. Additionally, the localization of an audio object may seem more elevated vertically than intended. These observations are especially common for frontal audio objects (i.e., audio objects whose intended localization is substantially within the listener's visual field).

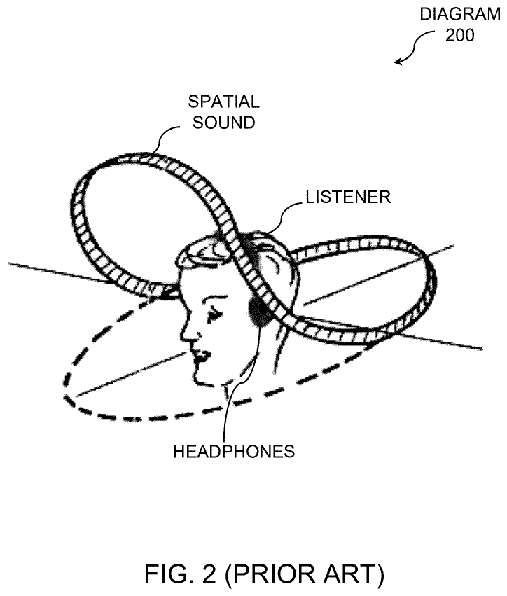

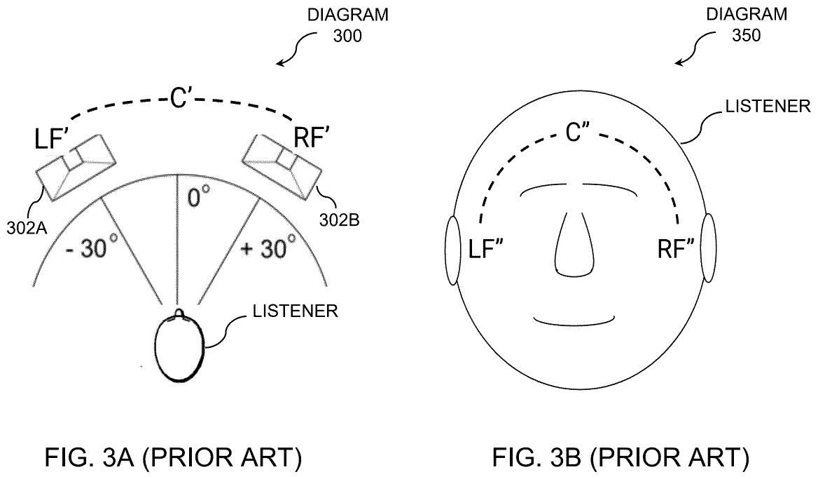

FIG. 2 depicts a diagram 200 illustrating a commonly reported listening experience during the binaural reproduction of a circular motion of an audio object in the horizontal plane, recorded with a dummy head microphone in accordance with embodiments of the present disclosure. As reported by one professional: “the most common case is to feel as though the source moves up as it passes in front.” FIG. 3A depicts a diagram 300 illustrating a listener with a left loudspeaker 302A and a right loudspeaker 302B in accordance with embodiments of the present disclosure.

FIG. 3B depicts a diagram 350 illustrating a commonly perceived in-head localization in the binaural audio playback of two-channel stereo audio signals in accordance with embodiments of the present disclosure. The intended localization, as experienced in a standard stereo loudspeaker reproduction as illustrated in FIG. 3A, is frontal and outside of the listener's head. In binaural reproduction, such discrepancies between intended and perceived localization are also commonly experienced with surround or immersive multi-channel or object-based audio source signals.

Known mitigating factors include the simulation of virtual or local room acoustic reverberation or reflections, the dynamic compensation of the listener's head motion, the customization of head-related and headphone-related transfer functions, and the provision of congruent visual information. These methods are not suitable or practical in all application scenarios because they require additional system complexity or particular listening conditions. Additionally, they may themselves cause undesirable side effects, such as audible and objectionable audio fidelity deteriorations relative to the audio source signal.

What is needed is a method for restoring the natural perception of external localization and frontal localization in the binaural reproduction of audio objects that does not cause objectionable audio fidelity deteriorations and does not add significant complexity in the realization of binaural audio reproduction systems.

Methods according to the present invention are referred to collectively as externalization processing methods. A novel and unique benefit of these methods is to alleviate the frontal localization discrepancy as illustrated in FIG. 2 and the external localization discrepancy illustrated in FIG. 3B, while preserving the timbre of any audio source signal.

Methods according to the present invention can be implemented in conjunction with the simulation of virtual or local room acoustic reverberation or reflections, the dynamic compensation of the listener's head motion, and the customization of head-related and headphone-related transfer functions.

Methods according to the present invention are applicable to enhancing the decoding and binaural reproduction of audio source signals delivered in immersive audio formats such as Dolby Atmos and MPEG-H; or rendered over head-mounted binaural reproduction devices for VR or augmented reality (AR) applications.

Binaural externalization processing methods according to the present disclosure operate to (1) receive an audio source signal, (2) generate a directional signal by applying directional processing to the audio source signal, (3) generate a tail output signal by applying diffuse tail processing to the audio source signal, (4) generate an externalized signal by combining the directional signal and tail output signal. The tail output signal is representative of the directional signal. Additionally, the tail output signal is configured for conveying diffuse localization and the externalized signal is configured for conveying directional localization.

Further FIG. 3A illustrates, in a top-down view, the localization perceived by a listener in the reproduction of a two-channel stereo audio source signal in the conventional stereo loudspeaker playback configuration. The symbols (LF′), (RF′) and (C′) respectively represent the perceived localization of a left-channel audio object, a right-channel audio object, and a center-panned audio object transmitted equally over the left and right audio source signal channels. The perceived localization coincides respectively with the position of the left loudspeaker, the position of the right loudspeaker, and a notional front center position.

Further in FIG. 3B, symbols (LF″), (RF″) and (C″) respectively represent the perceived localization of a left-channel audio object, a right-channel audio object, and a center-panned audio object transmitted equally over the left and right audio source signal channels. The perceived localization coincides respectively with the left-ear position, the right-ear position, and a position near the center of the listener's head.

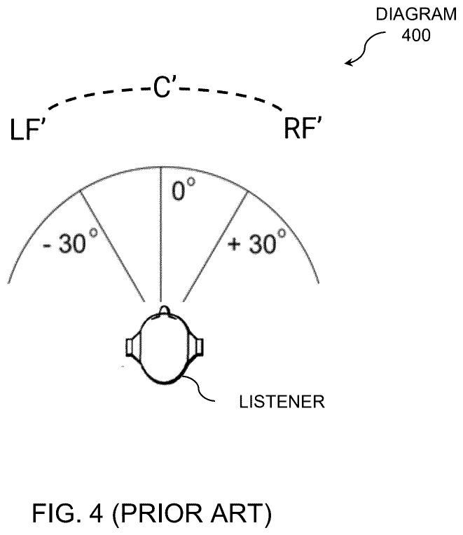

FIG. 4 depicts a diagram 400 illustrating, in a top-down view, the intended localization to be perceived by a listener in the binaural reproduction of a two-channel stereo audio source signal in accordance with embodiments of the present disclosure. The symbols (LF′), (RF′) and (C′) respectively represent the intended localization of a left-channel audio object, a right-channel audio object, and a center-panned audio object transmitted equally over the left and right audio source signal channels. By comparing FIG. 4 and FIG. 3A, the intended localization coincides respectively with the notional positions of a left-front virtual loudspeaker, a right-front virtual loudspeaker, and a notional front center position.

As is well known in the art, directional processing methods have been developed with the goal of simulating, in binaural reproduction, the auditory experience of attending a live performance, or of listening to an audio recording via a loudspeaker reproduction system. In the case of a two-channel stereo audio source signal, as illustrated in FIG. 4, the goal of directional processing is to simulate, in binaural reproduction, the auditory experience of playing back the audio source signal over a frontal stereo loudspeaker system. More generally, in the present disclosure, a directional processing method is any method that can be used to convert a source audio signal into a two-channel directional signal, comprising a left-ear channel (L) and a right-ear channel (R), such that the binaural reproduction of the directional signal simulates the intended localization of the audio objects that compose the audio source signal.

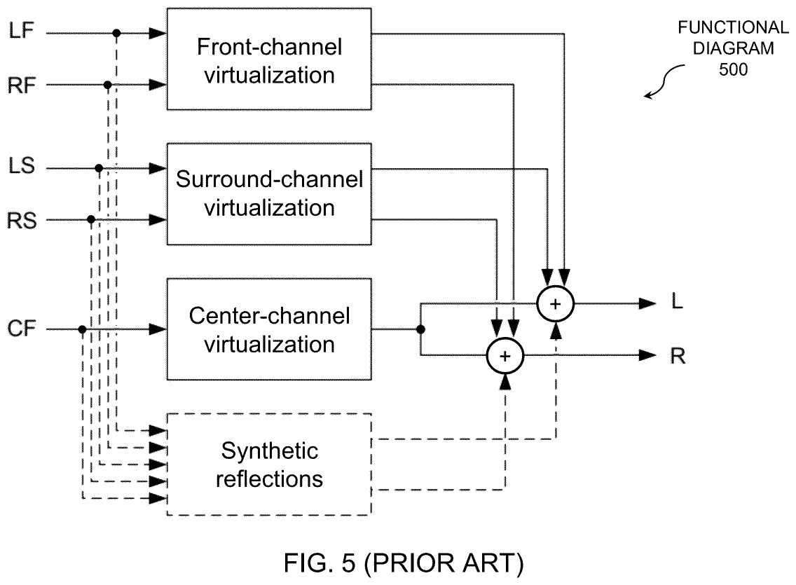

FIG. 5 depicts a functional diagram 500 illustrating directional processing of a five-channel audio source signal designed for playback in the standard surround-sound loudspeaker configuration shown in FIG. 1 in accordance with embodiments of the present disclosure. Diagram 500 includes the following audio channels: left-front, center-front, right-front, left-surround, right-surround, respectively labeled (LF), (CF), (RF), (LS), (RS). As is well known in the art and illustrated in FIG. 5, directional processing is commonly performed by a process known as virtualization, based on audio signal filters that approximate a pair of head-related transfer functions (HRTF) for a given intended direction of apparent sound arrival. In FIG. 5, the virtualization processing is represented separately for the front audio channel pair, the surround audio channel pair, and the center audio channel.

Additionally, as illustrated in FIG. 5, a synthetic reflections processing block is used to simulate the experience of listening to the set of virtual loudspeakers in a virtual room. As is well known in the art, synthetic reflections processing methods, also referred to generally as artificial reverberation methods, are commonly employed in order enhance the perceived sense of naturalness of the listening experience in binaural reproduction.

Other well known techniques used in directional processors include direct-diffuse decomposition to render reverberation or ambience components already present in the source material as diffuse sound components, and up-mixing techniques to mitigate the incorrect matching of natural HRTF cues for audio objects panned across two or more virtual loudspeakers. These methods are equivalent to decomposing the audio source signal into a plurality of audio objects and applying virtualization processing to each of these component audio objects.

Directional processing methods applied to multi-channel or multi-object audio source signals suffer from the objectionable artifacts commonly observed for single-channel audio source signals. Examples include in-head localization, spurious elevation or front-to-back confusion in the perceived localization of audio objects (especially for frontal audio objects), and timbre coloration (often attributed at least in part to the inclusion of synthetic reflections processing, causing the timbre of the processed signal to sound different from the timbre of the audio source signal).

The binaural externalization processing methods described in the present disclosure do not rely on the simulation of virtual loudspeakers or sound sources in a virtual room. Instead, they concentrate on delivering binaural cues that are experienced consistently in natural everyday listening conditions, regardless of the listening room, in the form of spatial relations between direct and diffuse sound-field components. For audio-only content (such as music or podcasts), binaural externalization processing can reduce listening fatigue and facilitate the auditory spatial interpretation of the intended audio scene. For audio-visual content and experiences, such as video, teleconference, VR or AR, it can alleviate cognitive load by improving the spatial coincidence of perceived auditory and visual cues.

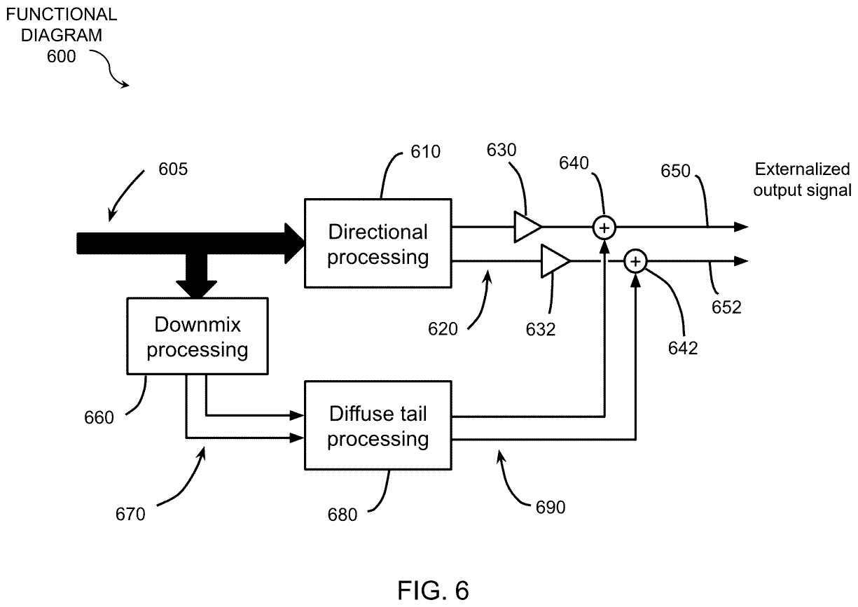

FIG. 6 depicts a functional diagram 600 illustrating a signal flow diagram illustrating the binaural externalization processing of an audio source signal in accordance with embodiments of the present disclosure. The audio source signal 605 may be a single-channel signal, a two-channel signal, a multi-channel signal, an Ambisonic signal, an object-based signal or any combination thereof. The audio source signal 605 is fed to the directional processing block 610 and to the downmix processing block 660. Block 610 may be realized by any of the existing directional processing methods described previously in this disclosure, and produces the directional signal 620. The downmix processing block 660 is provided if the audio source signal is composed of a plurality of elementary audio source signals or comprises more than two channels. Block 660 outputs a single-channel or two-channel tail input signal 670, which is fed to the diffuse tail processing block 680. Block 680 produces the two-channel tail output signal 690. The outputs of directional processing block 610 are sent to dry gain correctors 630 and 632, whose outputs are combined with the tail output signal 690 to produce the two-channel externalized signal (650, 652). As is well-known in the art, the audio signal processing operations described herein may be implemented indifferently in time-domain, frequency-domain, or short-time Fourier transform (STFT) domain.

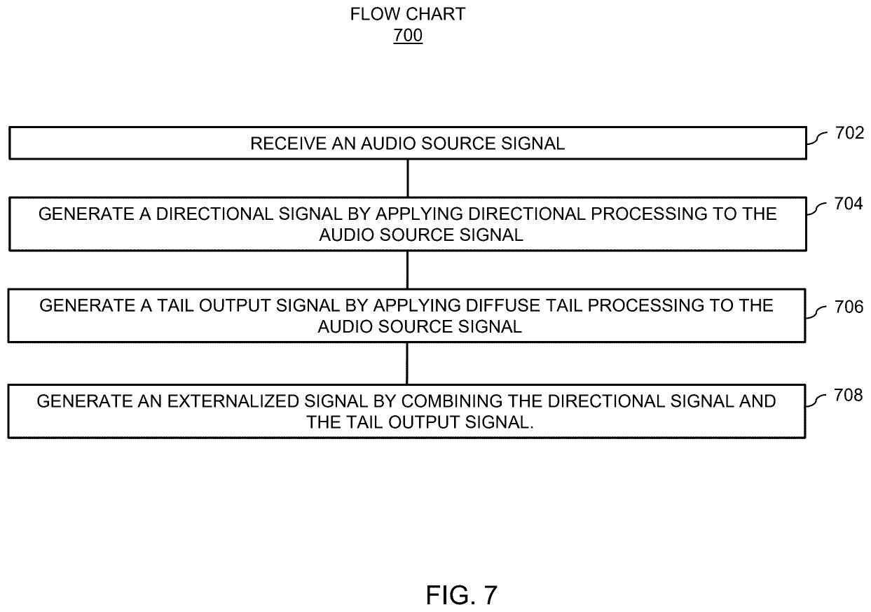

In broader embodiments, FIG. 7 depicts a flowchart 700 illustrating a method for reproducing spatial audio using binaural externalization processing extensions in accordance with embodiments of the present disclosure. At least a portion of the method may be implemented by one or more processors, one or more application specific integrated circuits (ASICs), one or more digital signal processors (DSPs), one or more field programmable gate arrays (FPGAs), and/or the like

In step 702, the method includes receiving an audio source signal. The audio source signal may be a multi-channel audio source signal, a binaural source signal, an Ambisonic audio source signal having a W component channel, or the like.

For example, a two-channel audio signal conveying directional localization is one that, in binaural reproduction, is perceived as including at least one element with a specific apparent direction of sound arrival. If, on the other hand, a two-channel audio signal, that is not silent, does not convey directional localization, then it is qualified as conveying diffuse localization. Diffuse localization is unspecific or blurry localization. Examples of audio signals conveying diffuse localization are the sound of a swarm of bees surrounding the listener, or the sound of room reverberation in common spaces. As is well known in the art, an objective diffuseness metric for a two-channel audio signal (L, R) is the interchannel coherence coefficient (denoted ICC), which is a function of frequency f: ICC(f)=|GLR(f)|2/(GLL(f). GRR(f)), where GLR(f) denotes the cross-spectral density of the two channels, and where GLL(f) and GRR(f) denote, respectively, the spectral density of the signals L and R.

In step 704, the method further includes generating a directional signal by applying directional processing to the audio source signal. Applying directional processing may include applying interaural time difference.

In step 706, the method further includes generating a tail output signal by applying diffuse tail processing to the audio source signal. The tail output signal is representative of the directional signal. Additionally, the tail output signal is configured for conveying diffuse localization. Applying diffuse tail processing may include applying a delay network. The delay network may include at least one feedback delay network (FDN).

The method (not shown in FIG. 7) may further include applying downmixing to the audio source signal prior to applying the diffuse tail processing. Applying the downmixing to the audio source signal may include normalization processing. The normalization processing may be configured for ensuring that the tail output signal is representative of the directional signal. Additionally, applying the downmixing to the audio source signal may include preservation of per-source interaural time differences (ITD). When applicable, the diffuse tail processing may be applied to the W component channel of the audio source signal.

Applying diffuse tail processing may include applying a frequency-dependent rotation matrix. The frequency-dependent rotation matrix may include a first shelving filter and a second shelving filter. The first shelving filter may have a first power frequency response over a frequency range targeted for a user; and the second shelving filter may have a second power frequency response over the frequency range targeted for the user. The first power frequency response may be complementary to the second power frequency response. The first shelving filter may include a high-pass equalizer and the second shelving filter may include a low-pass equalizer. Applying diffuse tail processing may further include applying at least one feedback delay network (FDN) in cascade with the frequency-dependent rotation matrix.

In step 708, the method further includes generating an externalized signal by combining the directional signal and tail output signal. The method (not shown in FIG. 7) may further include applying gain correction to the directional signal prior to combining the directional signal and the tail output signal. The externalized signal is configured for conveying directional localization. For example, the externalized signal may be conveyed to a listener. The externalized signal may be representative of the audio source signal.

The method (not shown in FIG. 7) may further include applying reflections and/or reverb to the audio source signal to generate a reverb output signal. Additionally, the method may further include applying a diffuse-field an HRTF filter to the reverb output signal and combining an output of the diffuse-field HTRF filter with the externalized signal.

The method (not shown in FIG. 7) may further include providing the externalized signal to playback circuitry, storing the externalized signal in a memory, transmitting the externalized signal over a communication interface, and/or the like. The playback circuitry may include at least two loudspeakers.

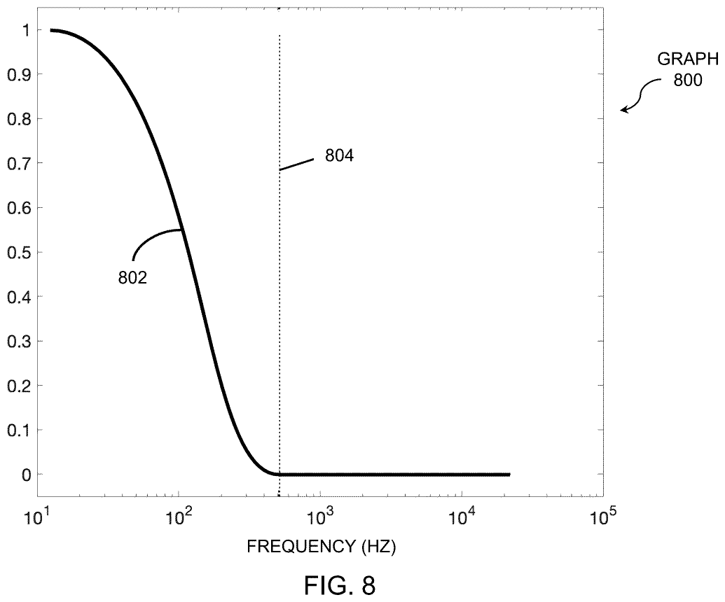

FIG. 8 depicts a graph 800 illustrating a simplified plot of interchannel coherence of a two-channel signal conveying diffuse localization in binaural reproduction in accordance with embodiments of the present disclosure. The curve 802 represents ICC as a function of frequency. Above the transition frequency 804 (approximately 500 Hz) the two signals are mutually incoherent (also qualified as uncorrelated). As frequency decreases below the transition frequency, the coherence increases gradually and eventually reaches 1.0 at 0 Hz. At 0 Hz, the Left and Right signals are coherent (or correlated).

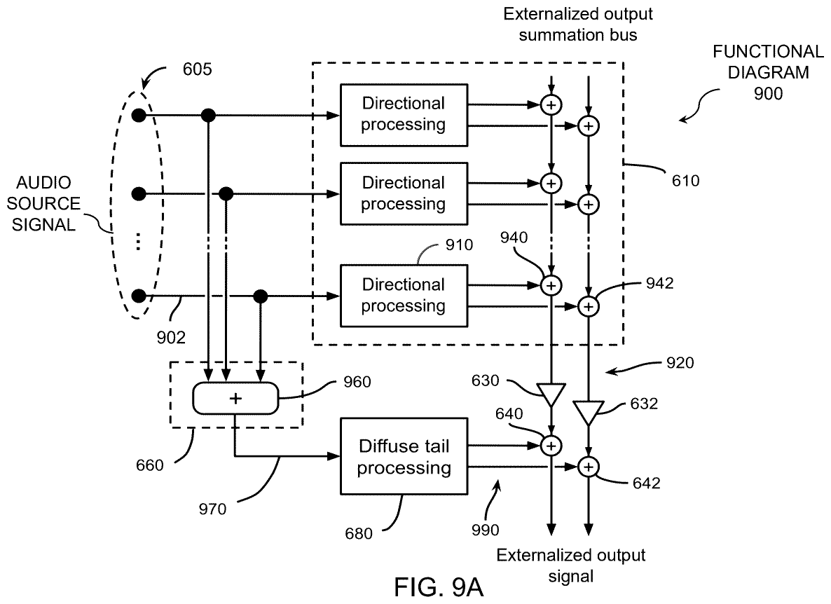

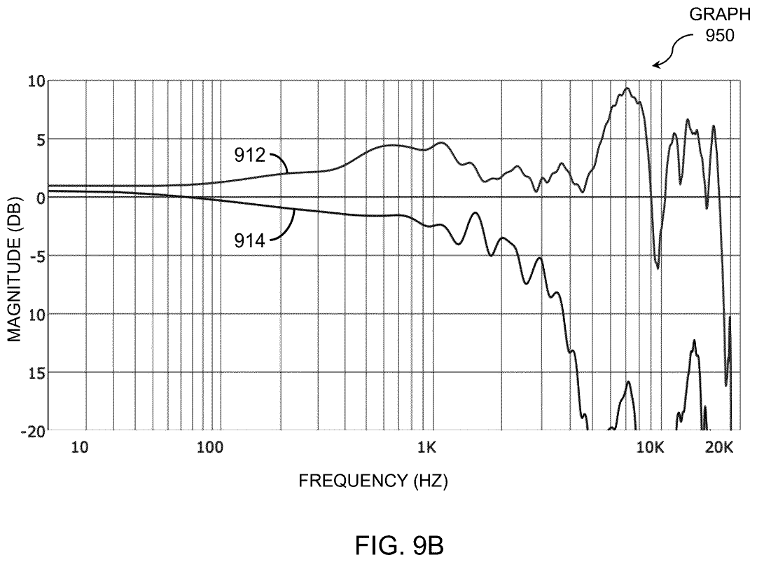

FIG. 9A depicts a functional diagram 900 illustrating a signal flow diagram illustrating the binaural externalization processing of a multi-channel audio source signal 605 composed of a set of elementary single-channel audio source signals feeding a shared diffuse tail processing block 680, in accordance with embodiments of the present disclosure. Each elementary audio source signal 902 feeds a separate elementary directional processing block 910, whose output contributes to the directional signal 920 by use of the pair of summation functions (940, 942). The directional processing block 610 is the parallel association of the elementary directional processing blocks. The downmix block 660 performs the summation of the elementary single-channel source audio signals to produce the single-channel tail input signal 970. The diffuse tail processing block 680 produces the tail output signal 990, which is combined with the directional signal 920 to generate the externalized output signal. Each one of the different elementary audio source signals may represent audio objects individually assigned to a different localization expressed by an azimuth angle and an elevation angle. Collectively, the set of audio objects may constitute an immersive multichannel audio source signal wherein each audio input channel is assigned a fixed position on a virtual sphere centered on the listener, relative to the front-center direction.

In one embodiment of the binaural externalization processor of FIG. 9A, each elementary directional processing block 910 outputs an elementary directional signal, by simulating the pair of HRTF filters for the direction assigned to its corresponding elementary audio object, whereas the diffuse tail processing block is shared among several objects.

FIG. 9B depicts a graph 950 illustrating two plots (912, 914) of a pair of filters in accordance with embodiments of the present disclosure. The two plots (912, 914) are from a pair of HRTF filters for azimuth and elevation angles respectively set to 90 degrees and 0 degrees. Plots (912, 914) represent, respectively, the ipsilateral and contralateral magnitude HRTFs. In one embodiment, the HRTF filters used in all elementary directional processing blocks are diffuse-field compensated (i.e., the average of all their magnitude HRTFs over all directions in space is 0 dB at all frequencies). An advantage of employing diffuse-field compensated HRTF filters in the directional processing block 610 according to the present invention is that the directional signal produced by the directional processing block is similar in perceived timbre to the audio source signal 605.

As a general definition, in the context of the present invention, two audio signals are qualified as mutually representative if they are perceived as having substantially the same timbre, even though they may have different perceived loudness or localization. For instance, they may both convey directional localizations differing in azimuth, elevation or externalization. Two audio signals may be mutually representative (similar in their timbre), although one conveys directional localization while the other conveys diffuse localization. For instance, pseudo-stereo processing is a well-known example of audio signal processing function that generates a representative signal conveying diffuse localization from a single-channel audio signal.

Artificial reverberation processing can also be employed to generate an audio signal that conveys diffuse localization from a single-channel input audio signal. However, since artificial reverberation processing is designed to simulate the acoustics of a room (such as the synthetic reflections block in FIG. 5), it does not generate an output audio signal that is representative of its audio source signal. As is well known in the art of audio engineering, the timbre of a reverberator's output signal is noticeably different from the timbre of its input signal, in terms of tonal color and temporal resonance.

Conditions (a) through (c) must be verified in order to ensure that the externalized signal constitutes a perceptually valid extension for the directional signal, according to embodiments of the present disclosure.

Condition (a): the application of the diffuse tail processing 680 should preserve the timbre of the directional signal 620.

Condition (b): the duration of the time response of the tail processing block 680 must be brief enough to avoid audible temporal smearing of transient or percussive sounds present in the directional signal

Condition (c): the loudness of the tail output signal 690 must be controlled and the correction gains (630, 632) adjusted so that the loudness of the externalized signal matches the loudness of the directional signal.

Conditions (a) and (b) above rule out the inclusion of artificial reverberation processing (room simulation) in the tail processing block.

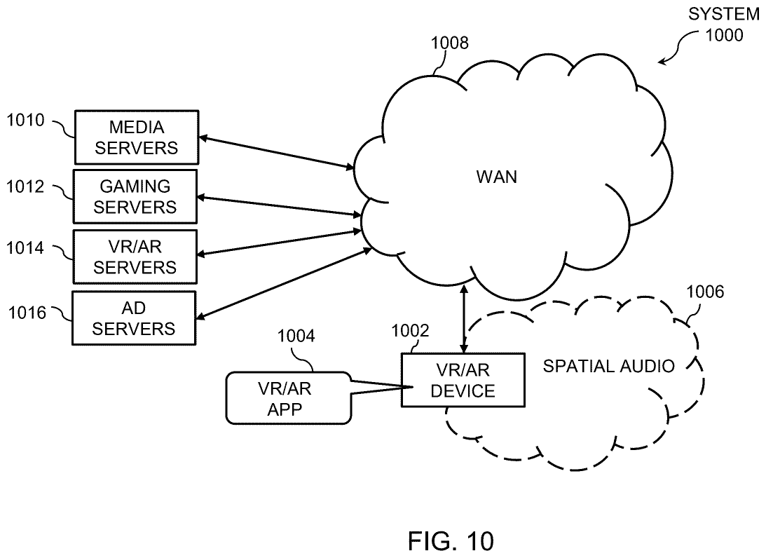

FIG. 10 depicts a block diagram illustrating a system 1000 for providing binaural externalization processing extensions for reproducing spatial audio in accordance with embodiments of the present disclosure. The system 1000 includes a VR/AR device 110 executing a VR/AR application (app) 1004. The VR/AR device is capable of reproducing spatial audio 1006. The VR/AR device 1002 is communicatively coupled over a wide area network (WAN) to one or more media servers 1010, one or more gaming servers 1012, one or more VR/AR servers 1014, and one or more advertising (ad) servers 106. In some embodiments, the system 1000 may include other types of devices configure for reproducing spatial audio. These devices may include smart phones, smart tablets, headphones, soundbars, and/or the like.

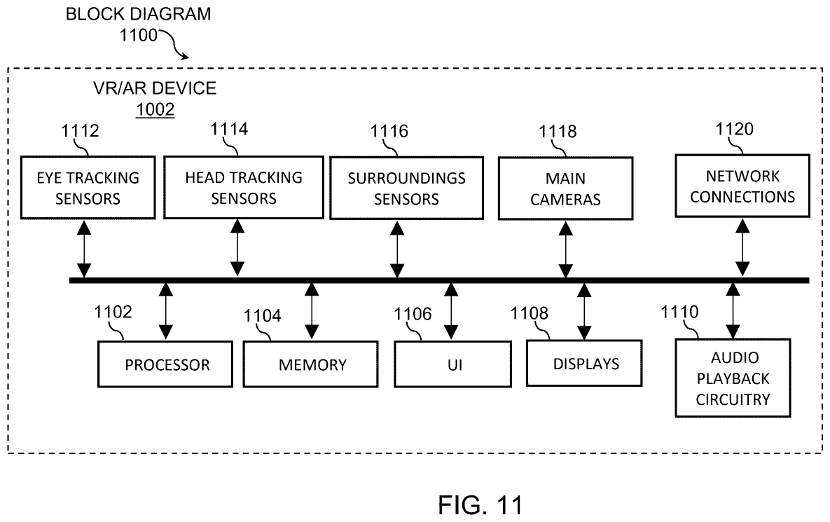

FIG. 11 depicts a block diagram 11000 further illustrating one embodiment of the VR/AR device 1002 of FIG. 10 in accordance with embodiments of the present disclosure. The VR/AR device 1002 may include at least a processor 1102, a memory 1104, a user interface (UI) 1106, displays 1108, and speakers 1010. The memory 1104 may be partially integrated with the processor 102. The memory 1104 may include a combination of volatile memory (e.g., random access memory) and non-volatile memory (e.g., flash memory). The UI 1106 may include a touchpad display. The displays 1108 may include left and right displays for each eye of a user. The audio playback circuitry 1110 may be positioned within the VR/AR device 1002. In other embodiments, the audio playback circuitry 1110 may be provided as earbuds or headphones. Connections to the audio playback circuitry 1110 may be wired or wireless (e.g. Bluetooth®).

The VR/AR device 1002 may also include eye tracking sensors 1112, head tracking sensors 1114, surroundings sensors 1116, main cameras 1118, and network connections 1120. The eye tracking sensors 112 may include cameras co-positioned with the displays 308. The head tracking sensors 1114 may include a three-axis gyroscope sensor, an accelerometer sensor, a proximity sensor, and/or the like. The surroundings sensors 1116 may include cameras positioned at a plurality of angles to view an outward circumference of the VR/AR device 1002. The main cameras 1018 may include high resolutions cameras configured to provide main left eye and main right eye views to the user.

The network connections 320 may include WAN radios, local area network (LAN) radios, personal area network (PAN radios), and/or the like. The WAN radios may include 2G, 3G, 4G, and/or 5G technologies. The LAN radios may include Wi-Fi technologies such as 802.11a, 802.11b/g/n, and/or 802.11ac circuitry. The PAN radios may include Bluetooth® technologies.

In some embodiments, VR/AR device 1002 may be a VR headset. For example, the VR/AR device 1002 may be an Oculus Quest VR headset, an Oculus Quest 2 VR headset, an Oculus Go headset, a Pico Neo 1 VR headset, a Pico Neo 2 VR headset, a Pico Neo 3 VR headset, a Pico Goblin 1 VR headset, a Pico Goblin 2 VR headset, an HTC VIVE Focus VR headset, HTC VIVE Focus Plus VR headset, an HTC VIVE Focus 3 VR headset or the like.

In other embodiments, VR/AR device 1002 may be an AR headset. For example, the VR/AR device 1002 may be a Hololens 1 AR headset, a Hololens 2 AR headset, a Magic Leap 1 AR headset, or the like.

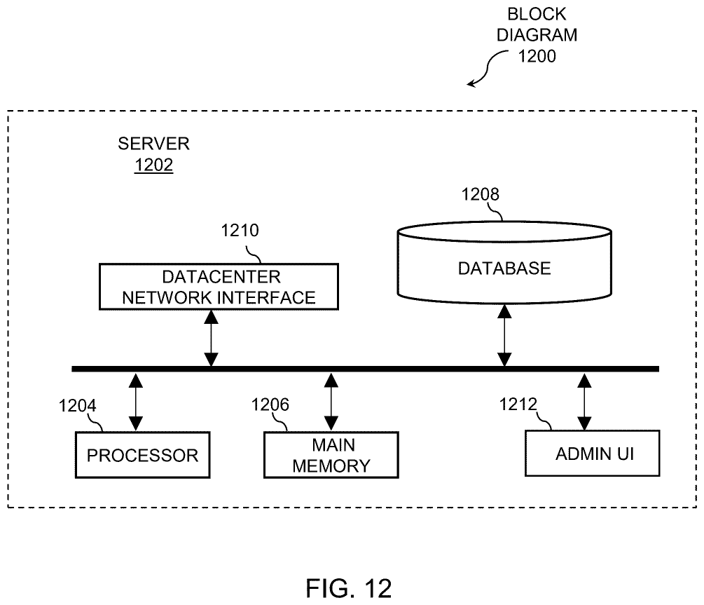

FIG. 12 depicts a block diagram 1200 illustrating a server 1202 in accordance with embodiments of the present disclosure. The server 1202 may be representative of one or more of the media servers 110, the gaming servers 1012, the VR/AR servers 1014, and/or the ad servers 1016.

The server 1202 includes at least one of processor 1204, a main memory 1206, a storage memory (e.g., database) 1208, a datacenter network interface 1210, and an administration UI 1212. The server 1202 may be configured to host an Ubuntu® server. In some embodiments Ubuntu® server may be distributed over a plurality of hardware servers using hypervisor technology.

The processor 1204 may be a multi-core server class processor suitable for hardware virtualization. The processor may support at least a 64-bit architecture and a single instruction multiple data (SIMD) instruction set. The main memory 1206 may include a combination of volatile memory (e.g., random access memory) and non-volatile memory (e.g., flash memory). The database 1208 may include one or more hard drives.

The datacenter network interface 1210 may provide one or more high-speed communication ports to the data center switches, routers, and/or network storage appliances. The datacenter network interface 608 may include high-speed optical Ethernet, InfiniBand (IB), Internet Small Computer System Interface (iSCSI), and/or Fibre Channel interfaces. The administration UI may support local and/or remote configuration of the server 1202 by a datacenter administrator.

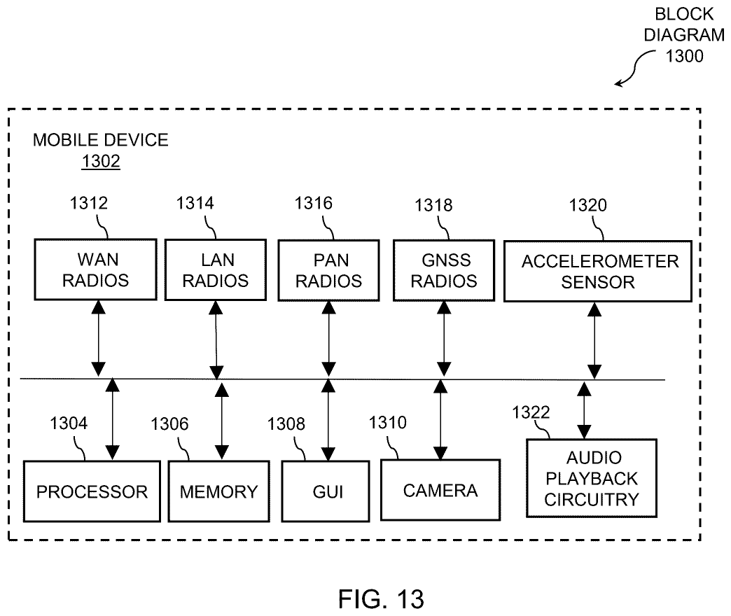

FIG. 13 depicts a block diagram 1300 illustrating a mobile device 1302 in accordance with embodiments of the present disclosure. The mobile device 1302 may be a smart phone (e.g., cell phone), a tablet, a laptop, a smart watch, or the like. The mobile device 1302 includes a processor 1304, a memory 1306, a graphical user interface (GUI) 1308, a camera 1310, WAN radios 1312, LAN radios 1314, PAN radios 1316, GNSS radios 1318, and one or more accelerometer sensors 1320.

In some embodiments the memory 1306 or a portion of the memory 1306 may be integrated with the processor 1304. The memory 1306 may include a combination of volatile memory (e.g., random access memory) and non-volatile memory (e.g., flash memory). In certain embodiments, the processor 1304 may be a mobile processor such as the Qualcomm® Snapdragon® mobile processor. For example, the processor 1304 may be the Snapdragon@ 855 mobile processor. The GUI 1308 may be a touchpad display.

The WAN radios 1312 may include 2G, 3G, 4G, and/or 5G technologies. The LAN radios 1314 may include Wi-Fi technologies such as 802.11a, 802.11b/g/n, and/or 802.11ac circuitry. The PAN radios 1316 may include Bluetooth® and/or BLE technologies.

The audio playback circuitry 1322 may be positioned within the mobile 1302. In other embodiments, the audio playback circuitry 1322 may be provided as earbuds or headphones. Connections to the audio playback circuitry 1322 may be wired or wireless (e.g. Bluetooth®).

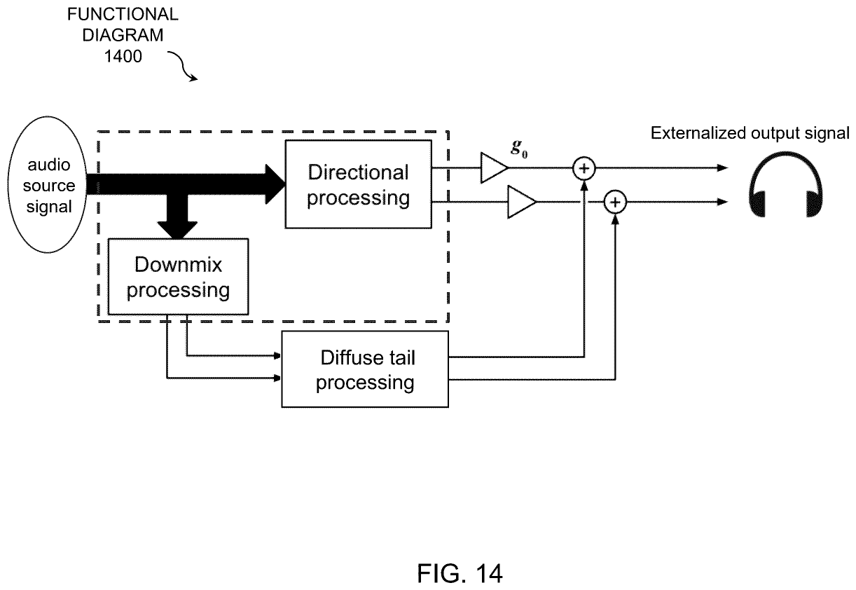

FIG. 14 depicts a functional diagram 1400 illustrating binaural externalization processing of an audio source signal in accordance with embodiments of the present disclosure. The audio source signal may be a single-channel signal, a two-channel signal, a multi-channel signal, an Ambisonic signal, an object-based signal or any combination thereof. The audio source signal is fed to the directional processing block and to the downmix processing block. In embodiments of the binaural externalization processing extensions described in the present disclosure, the directional processing block may be realized by any of the existing directional processing methods described in this document and may incorporate a function equivalent to downmix processing. The downmix processing outputs a single-channel or two-channel tail input signal, which is fed to the diffuse tail processing block. The diffuse tail processing block produces the two-channel tail output signal. The outputs of the directional processing block are scaled by a gain factor g0 and combined with the tail output signal to produce the two-channel externalized output signal. The value of the gain correction factor g0 is determined such that the externalized output signal is perceived to have substantially the same loudness as the directional signal.

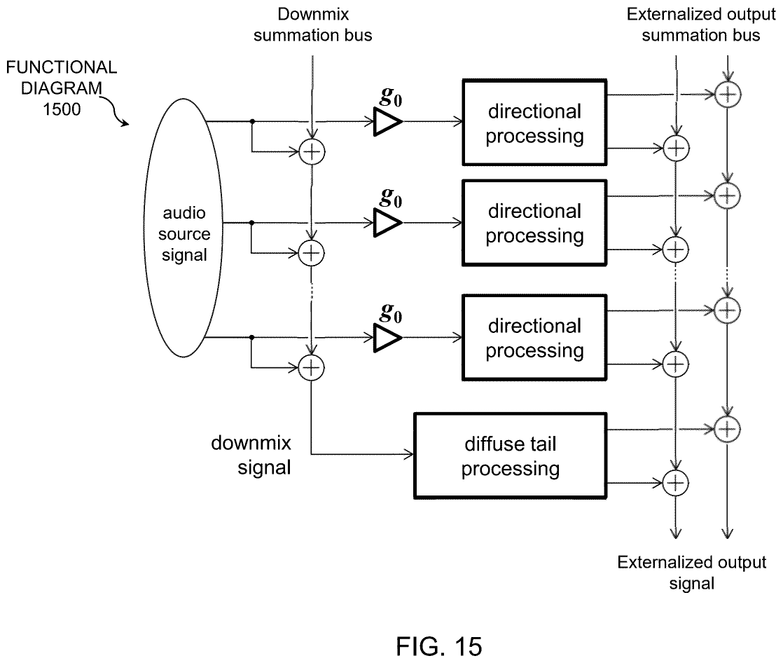

FIG. 15 depicts a functional diagram 1500 illustrating binaural externalization processing of a multi-channel source signal in accordance with embodiments of the present disclosure. The audio source signal is composed of a plurality of elementary single-channel audio source signals feeding a shared diffuse tail processing block. Each elementary audio source signal feeds a separate elementary directional processing block, whose output contributes to the externalized output summation bus block. The elementary single-channel source audio signals are combined into the downmix summation bus to produce the downmix signal which feeds the diffuse tail processing block. The output of the diffuse tail processing block is combined into the externalized output summation bus to generate the externalized signal.

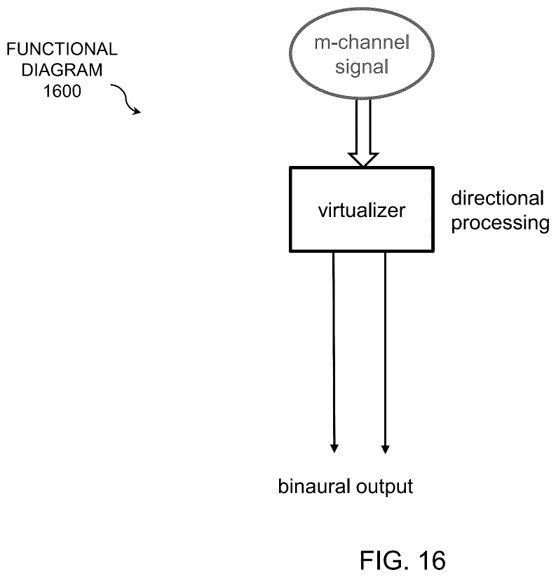

FIG. 16 depicts a functional diagram 1600 illustrating directional processing of a multi-channel source signal in accordance with embodiments of the present disclosure, by the application of a virtualization function which produces a directional signal.

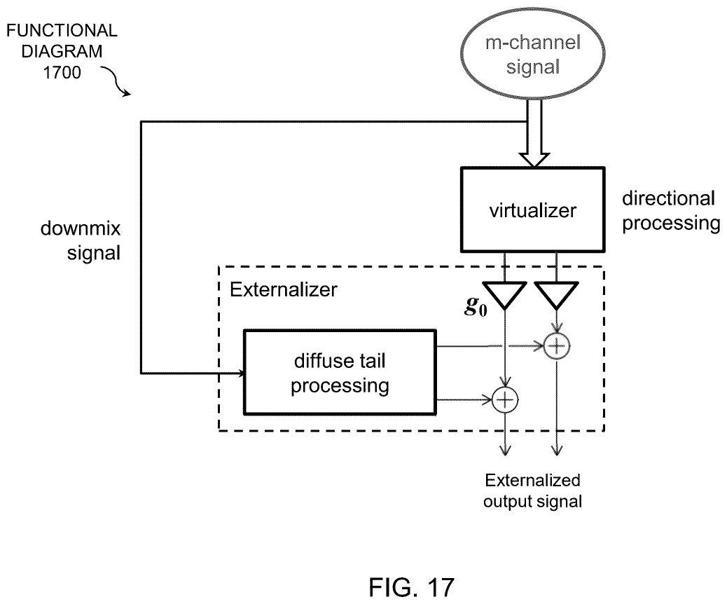

FIG. 17 depicts a functional diagram 1700 illustrating externalization processing of a multi-channel source signal in accordance with embodiments of the present disclosure. The directional signal, produced by the virtualizer block, is processed by an externalizer block to produce the externalized output signal. In the externalizer block, the directional signal is scaled by gain factor g0 and combined with the output of the diffuse tail processing block to produce the externalized output signal. The diffuse tail processing block is fed by a downmix signal derived from the multi-channel source signal. In some embodiments of the present invention, the downmix signal is derived by summation of single-channel signals included in the multi-channel source signal, as illustrated in FIG. 15.

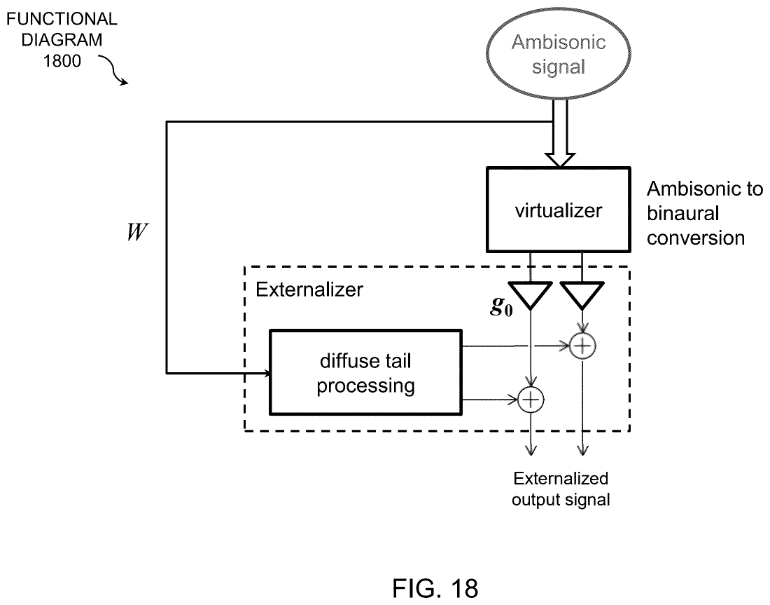

FIG. 18 depicts a functional diagram 1800 illustrating externalization processing of a multi-channel source signal in accordance with embodiments of the present disclosure, wherein the multi-channel source signal is encoded in Ambisonic format. As is well known in the art, an Ambisonic-formatted signal includes a component channel signal, conventionally labeled W, that contains a combination of all sound elements encoded in the Ambisonic signal. The externalizer block depicted in FIG. 18 includes a diffuse tail processing block that is fed by the component channel signal W included in the multi-channel source signal encoded in Ambisonic format.

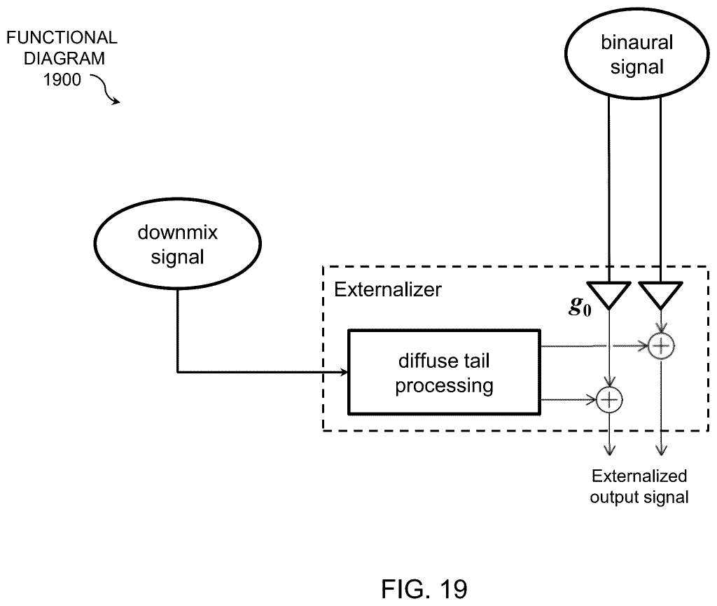

FIG. 19 depicts a functional diagram 1900 illustrating externalization processing of a binaural source signal in accordance with embodiments of the present disclosure. The source signal is processed by an externalizer block to produce the externalized output signal. In the externalizer block, the directional signal is scaled by gain factor g0 and combined with the output of the diffuse tail processing block to produce the externalized output signal. The diffuse tail processing block is fed by a downmix signal representative of the binaural source signal.

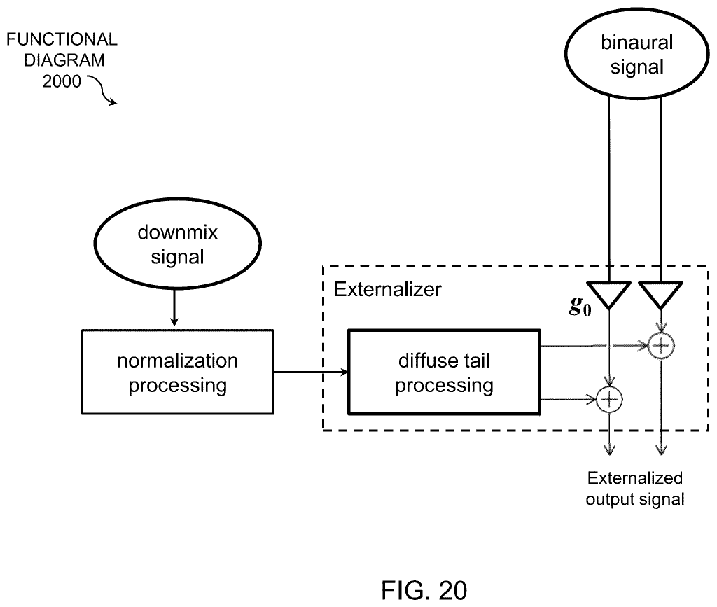

FIG. 20 depicts a functional diagram 2000 illustrating externalization processing of a binaural source signal in accordance with embodiments of the present disclosure per FIG. 19, wherein deriving the downmix signal includes normalization processing configured to ensure that the tail output signal is representative of the directional signal that is received by the externalizer block. In embodiments of the present disclosure wherein the directional signal is a diffuse-field compensated binaural signal (as defined previously in this disclosure), normalization processing may be omitted. In example embodiments, normalization processing may include a “zenith” HRTF filter, (i.e., an HRTF filter corresponding with an elevation angle set to 90 degrees.

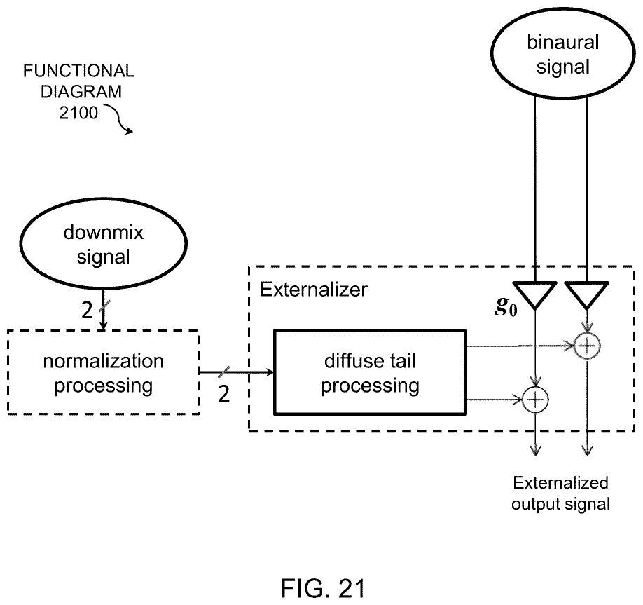

FIG. 21 depicts a functional diagram 2100 illustrating externalization processing of a binaural source signal in accordance with embodiments of the present disclosure per FIG. 19 or FIG. 20, wherein the downmix signal is a two-channel audio signal.

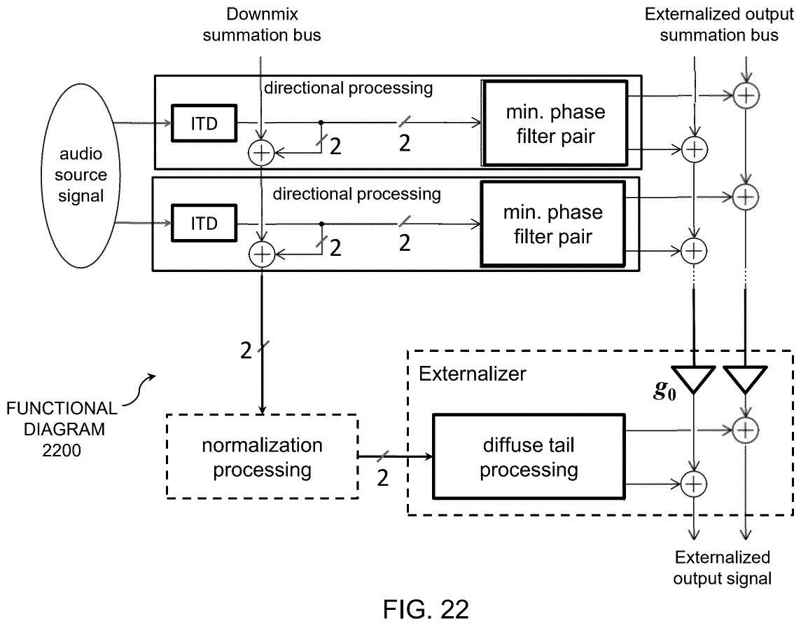

FIG. 22 depicts a functional diagram 2200 illustrating externalization processing of a binaural source signal in accordance with embodiments of the present disclosure per FIG. 21, wherein applying the downmixing to the audio source signal includes preservation of per-source ITD. Each of the elementary directional processing blocks is decomposed into two successive processing stages: an ITD processing block followed by a minimum-phase HRTF filter block. In each elementary directional processing block, the ITD processing block produces a Left signal and a Right signal having a relative temporal difference determined by a localization setting assigned to the corresponding elementary source signal. The two-channel downmix signal is obtained by summation of the two-channel outputs of the elementary ITD processing blocks.

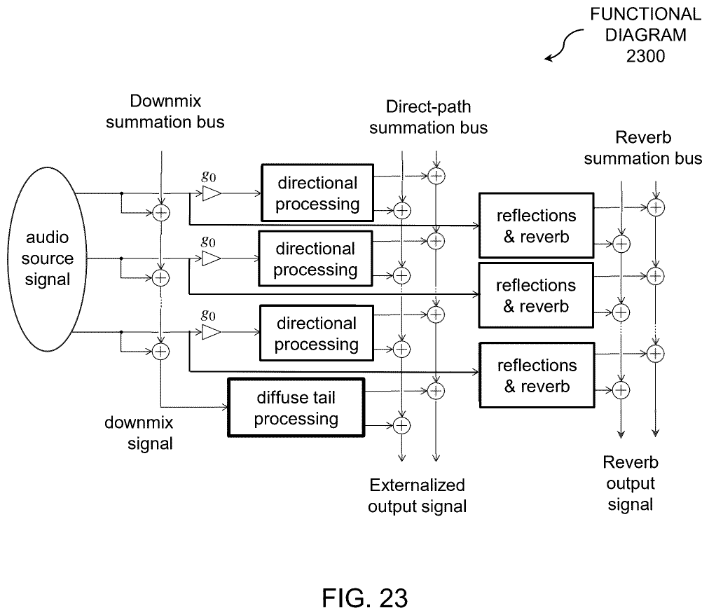

FIG. 23 depicts a functional diagram 2300 illustrating externalization processing of a multi-channel source signal in accordance with embodiments of the processing as depicted in any of FIGS. 15-22, wherein additional reflections and reverb processing is applied to each elementary source signal in order to generate a reverb output signal.

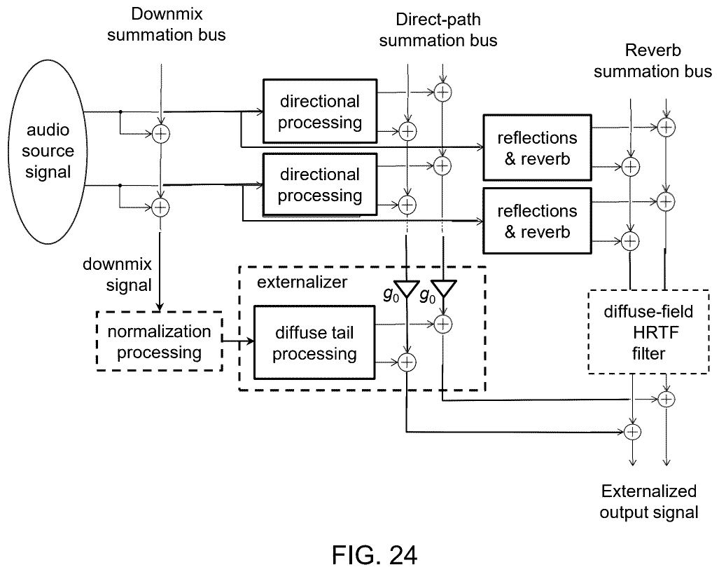

FIG. 24 depicts a functional diagram 2400 illustrating externalization processing of a multi-channel source signal in accordance with embodiments of the processing of FIG. 23, wherein the reverb output signal is combined with the externalized output signal. Optionally, a diffuse-field HRTF processing filter is applied to the reverb output signal prior to combining with the externalized output signal.

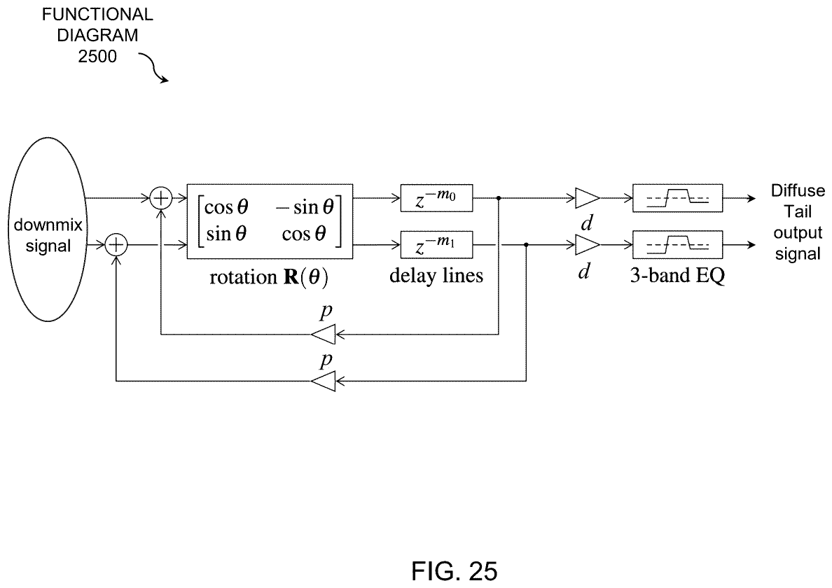

FIG. 25 depicts a functional diagram 2500 illustrating a diffuse tail processing block in accordance with embodiments of the present disclosure. The diffuse tail processing block receives the two-channel downmix signal, wherein the two channels may be identical if the downmix signal is single-channel. The two-channel downmix signal is rotated by a two-channel rotation matrix R(theta) and delayed by a two-channel delay line including a first delay unit of length equal to m0 samples and a second delay unit of length equal to m1 samples. The rotated and delayed two-channel signal is summed back into the tail input signal by a feedback loop including a feedback gain p such that |p|<1. Additionally, the diffuse tail output signal is further corrected by a gain d and an optional spectral corrector. In an example embodiment, the optional spectral corrector is implemented as a pair of three-band, second-order dual shelving filters. In an example embodiment, parameter settings are: average delay (m1+m0)/2=3 ms; channel delay difference (m1-m0)/(m1+m0)=20%; and feedback gain k=0.7.

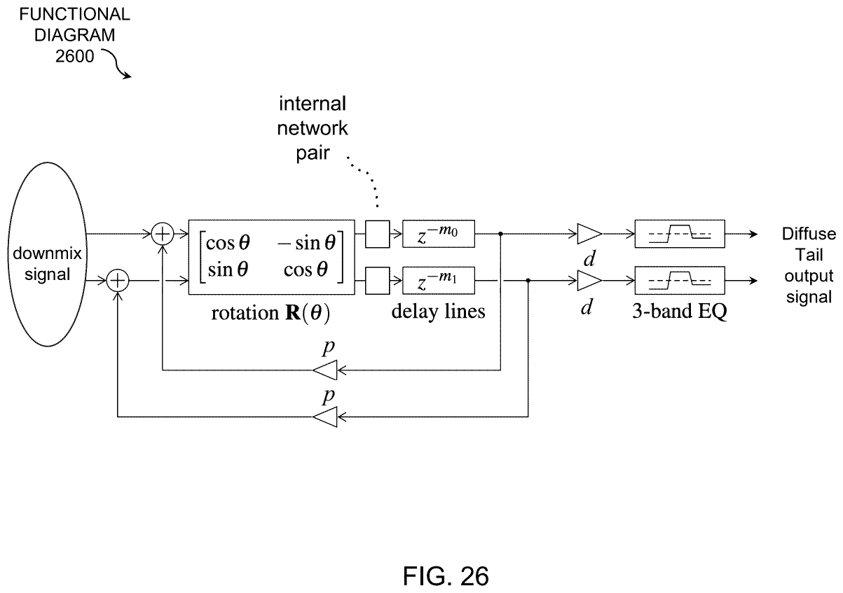

FIG. 26 depicts a functional diagram 2600 illustrating a diffuse tail processing block in accordance with embodiments of the present disclosure, wherein a mono-in, mono-out internal network is inserted between the rotation matrix and the two-channel delay line shown in FIG. 25, on either or both channels. In some embodiments, either or both of the internal networks is a unitary network. A unitary network is any delay network having a power-preserving input-to-output transfer function. The insertion of a unitary network has the effect of increasing feedback loop delay memory without modifying the energy of the diffuse tail output signal. Increasing feedback loop delay memory has the effect of increasing the modal density of the diffuse tail processing block, thereby adjusting the tonal character of the externalized output signal.

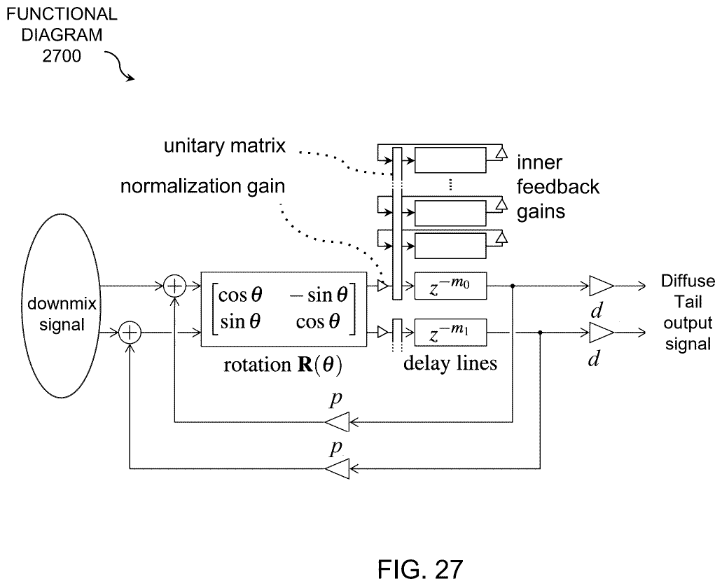

FIG. 27 depicts a functional diagram 2700 illustrating a diffuse tail processing block in accordance with embodiments of the present disclosure, wherein one or both of the internal networks inserted between the rotation matrix and the two-channel delay line (as shown in FIG. 26) is realized by a feedback delay network (FDN) comprising a parallel association of delay units coupled by a unitary matrix, each corrected by an inner feedback gain. In some embodiments, all inner feedback gains are equal to feedback gain p. In some embodiments, an internal normalization gain is applied to correct the power gain of an internal network.

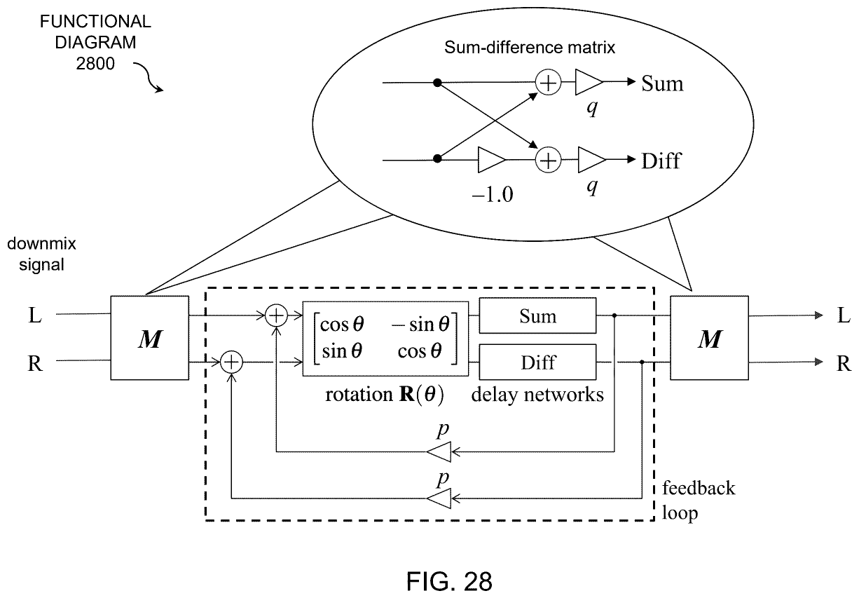

FIG. 28 depicts a functional diagram 2800 illustrating a diffuse tail processing block in accordance with embodiments of the present disclosure, such that varying angle theta enables control of the inter-channel correlation in the diffuse tail output signal. As in FIGS. 25, 26 and 27, diffuse tail processing includes a two-by-two rotation matrix R(theta) cascaded with a pair of delay networks within a two-channel feedback loop having feedback gain p. A sum-difference matrix M is inserted before and after the feedback loop such that the two-channel signal that circulates within the feedback loop is the signal (Sum, Diff) defined by: Sum=q*(L+R); Diff=q*(L−R). As is well known in the art, the sum-difference matrix M is power-preserving if q=1/sqrt(2). When theta is 0 degrees, matrix R is the identity matrix and the Sum and Diff signals circulate independently around the feedback loop. If the downmix signal is mono (L=R), then the tail output signal is also mono because the Diff signal is zero. When theta is nonzero, the downmix signal will feed both delay networks even if the downmix signal is mono. In preferred embodiments, the two delay networks (Sum and Diff) are different (for instance, the delay lengths m0 and m1 are different). As a result, the L and R output signals of the tail processing block are increasingly incoherent when theta increases, with the minimum coherence achieved when theta is 45 degrees (which implies that cos(theta)=sin(theta), resulting in maximum cross-feed through the rotation matrix R).

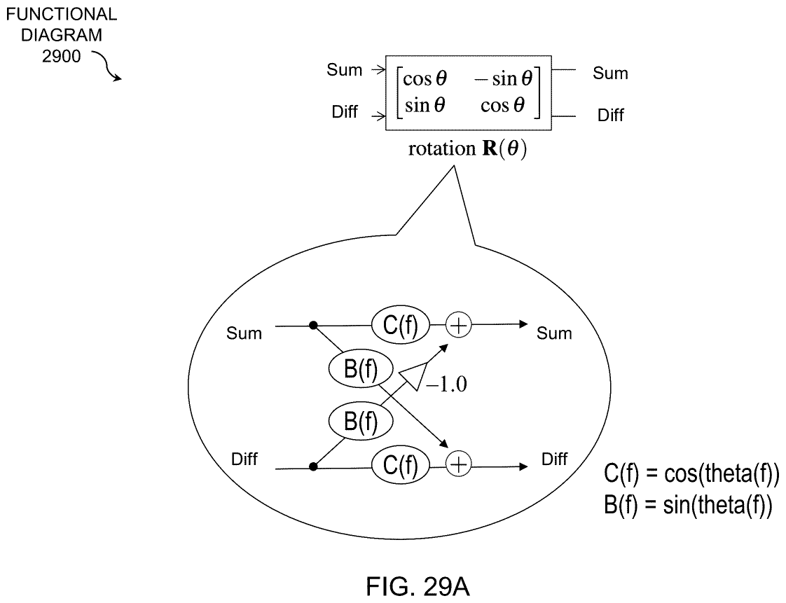

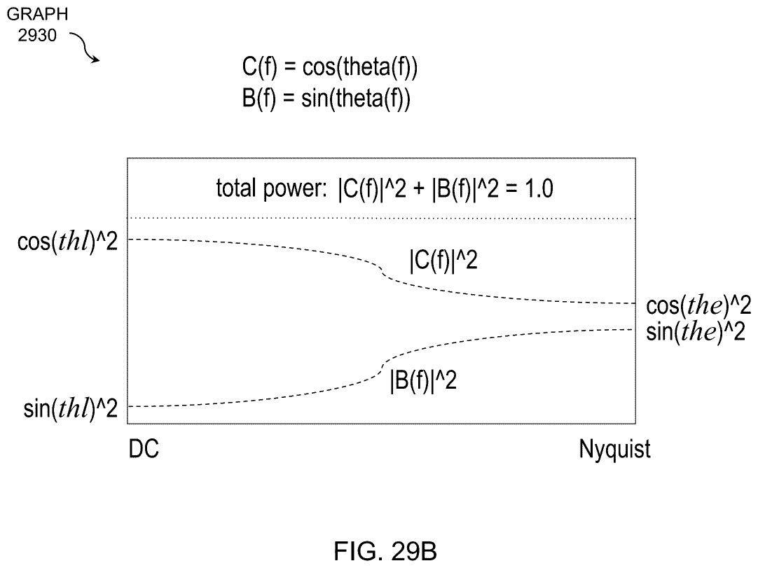

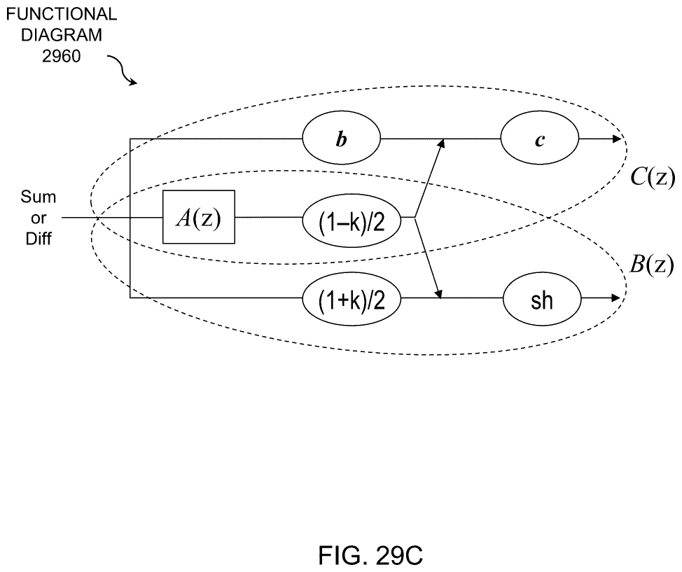

FIG. 29A depicts a functional diagram 2900 illustrating a realization of a frequency-dependent rotation matrix R(theta(f)) in accordance with embodiments of the present disclosure. The frequency-dependent rotation matrix is realized by employing two shelving filters having frequency responses equal respectively to: C(f)=cos(theta(f)); B(f)=sin(theta(f)).

FIG. 29B depicts a graph 2930 illustrating an example of the power frequency responses of shelving filters B and C in accordance with embodiments of the present disclosure, employed according to FIG. 29A. Theta varies with frequency: from value thl at DC (0 Hz) to value the at Nyquist. In this example, thl is close to zero whereas the is close to 45 degrees. Therefore, the degree of inter-channel coherence in the tail output signal is adjustable independently at low frequencies and high frequencies. The power frequency responses of shelving filters B and C add up to |C(f)|\hat{ }2+|B(f)|\hat{ }2=1.0 at any frequency so that an intermediate value of theta is realized. In preferred embodiments, shelving filter B is a high-pass filter while shelving filter C is a low-pass filter. In some embodiments, the inter-channel coherence in the tail output signal matches substantially the variation depicted in FIG. 8.

FIG. 29C depicts a functional diagram 2960 illustrating a realization of power-complementary shelving filters B and C in accordance with embodiments of the present disclosure. A denotes an all-pass filter whose transfer function is given by A(z)=−(a+z\hat{ }(−1))/(a*z\hat{ }(−1)+1) where a=(t−1)/(t+1) and t=tan(w/2), where w denotes the crossover frequency of shelving filters B and C. Shelving filter B is realized according to the well-known Regalia-Mitra topology, where k is the gain excursion k=s1/sh, where s1=sin(thl) and sh=sin(the). The complementary shelving filter C is realized by setting the coefficients b and c such that b=(ch+c1)/2c, where c=(ch−c1)/(1−k), c1=cos(thl) and ch=cos(the).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, SAS, Tensorflow, CUDA, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network including a PAN, LAN, or WAN, or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create an ability for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving an audio source signal;
generating a directional signal by applying directional processing to the audio source signal;
generating a tail output signal by applying diffuse tail processing to the audio source signal, wherein:
the tail output signal is configured for conveying diffuse localization;
the tail output signal is representative of the directional signal;
applying the diffuse tail processing includes applying a frequency-dependent rotation matrix;
the frequency-dependent rotation matrix includes a first shelving filter and a second shelving filter;
the first shelving filter has a first power frequency response over a frequency range targeted for a user; and
the second shelving filter has a second power frequency response over the frequency range targeted for the user; and
generating an externalized signal by combining the directional signal and the tail output signal, wherein the externalized signal is configured for conveying directional localization.

2. The method of claim 1 further comprising providing the externalized signal to playback circuitry.

3. The method of claim 1 further comprising storing the externalized signal in a memory.

4. The method of claim 1 further comprising transmitting the externalized signal over a communication interface.

5. The method of claim 1 further comprising applying downmixing to the audio source signal prior to applying the diffuse tail processing.

6. The method of claim 5, wherein applying the downmixing to the audio source signal includes preservation of per-source interaural time differences (ITD).

7. The method of claim 5, wherein applying the downmixing to the audio source signal includes normalization processing.

8. The method of claim 1 further comprising applying gain correction to the directional signal prior to combining the directional signal and the tail output signal.

9. The method of claim 1, wherein applying diffuse tail processing includes applying a delay network.

10. The method of claim 9, wherein the delay network includes at least one feedback delay network (FDN).

11. The method of claim 1, wherein:
the first power frequency response is complementary to the second power frequency response;
the first shelving filter includes a high-pass equalizer; and
the second shelving filter includes a low-pass equalizer.

12. The method of claim 1, wherein applying diffuse tail processing further includes applying at least one feedback delay network (FDN) in cascade with the frequency-dependent rotation matrix.

13. The method of claim 1 further comprising applying reflections and/or reverb to the audio source signal to generate a reverb output signal.

14. The method of claim 13 further comprising:
applying a diffuse-field head-related transfer function (HRTF) filter to the reverb output signal; and
combining an output of the diffuse-field HTRF filter with the externalized signal.

15. The method of claim 1, wherein applying directional processing includes applying interaural time difference.

16. The method of claim 1, wherein the externalized signal is representative of the audio source signal.

17. The method of claim 1, wherein the audio source signal is at least one of a multi-channel audio source signal, a binaural source signal, and an Ambisonic audio source signal having a W component channel.

18. The method of claim 17, wherein the audio source signal is an Ambisonic audio source signal and the diffuse tail processing is applied to the W component channel of the audio source signal.

19. A computing device comprising:
a memory; and
at least one processor configured for:
receiving an audio source signal;
generating a directional signal by applying directional processing to the audio source signal;
generating a tail output signal by applying diffuse tail processing to the audio source signal, wherein:
the tail output signal is configured for conveying diffuse localization;
the tail output signal is representative of the directional signal;
applying the diffuse tail processing includes applying a frequency-dependent rotation matrix;
the frequency-dependent rotation matrix includes a first shelving filter and a second shelving filter;
the first shelving filter has a first power frequency response over a frequency range targeted for a user; and
the second shelving filter has a second power frequency response over the frequency range targeted for the user;
and
generating an externalized signal by combining the directional signal and the tail output signal, wherein the externalized signal is configured for conveying directional localization.

20. A non-transitory computer-readable storage medium storing instructions to be implemented on at least one computing device including at least one processor, the instructions when executed by the at least one processor cause the at least one computing device to perform a method comprising:
receiving an audio source signal;
generating a directional signal by applying directional processing to the audio source signal;
generating a tail output signal by applying diffuse tail processing to the audio source signal, wherein:
the tail output signal is configured for conveying diffuse localization;
the tail output signal is representative of the directional signal;
applying the diffuse tail processing includes applying a frequency-dependent rotation matrix;
the frequency-dependent rotation matrix includes a first shelving filter and a second shelving filter;
the first shelving filter has a first power frequency response over a frequency range targeted for a user; and
the second shelving filter has a second power frequency response over the frequency range targeted for the user; and
generating an externalized signal by combining the directional signal and the tail output signal, wherein the externalized signal is configured for conveying directional localization.
